(19) United States
(12) Patent Application Publication
(10) Pub. No.: US 2006/0095266 A1
(43) Pub. Date: May 4, 2006

(54) Roaming user profiles for speech recognition

(76) Inventors: Megan McA'Nulty, Newton, MA (US); Allan Gold, Acton, MA (US); Stijn Van Even, Jamaica Plain, MA (US)

Correspondence Address: BROMBERG & SUNSTEIN LLP, 125 SUMMER STREET, BOSTON, MA, 02110-1618, US

(21) Appl. No.: 11/264,358

(22) Filed: Nov. 1, 2005

Related U.S. Application Data
(60) Provisional application No. 60/624,129, filed on Nov. 1, 2004.

(51) Int. Cl. G10L 21/00

(52) U.S. Cl. 704/270.1

(57) ABSTRACT

The invention relates to use of speech recognition on a computer network where users roam from one network location to another. A local workstation on the network includes a speech recognition application having a local user profile associated with an application user. The local user profile includes at least one synchronization file containing user-specific speech recognition data. A network file location remote from the local workstation contains a user master profile corresponding to the local user profile, including a copy of the local synchronization file.

This application claims priority from U.S. Provisional Patent Application 60/624,129, filed Nov. 1, 2004, the contents of which are incorporated herein by reference.

### FIELD OF THE INVENTION

invention relates to use of speech recognition on a computer network where users roam from one network location to another.

### BACKGROUND ART

One primary use of dictation software has been on a user's desktop computer. Some system users, particularly medical clinicians, may work in an environment where there is a pool of computers used for dictation, and they dictate to different computers in different sessions. We refer to such users as “roaming users.”

Modern dictation software adapts to users at a number of levels. A speech recognition system supporting roaming users needs to coordinate speech recognition models, vocabularies, and user customizations across the different computers used by roaming users. Because of the heavy computational requirements of speech recognition, using a centralized speech recognition server is not feasible in this situation. But simply using separate individual dictation software applications on multiple independent workstations is also not desirable because users' modifications and adaptations then are only available on one workstation. Some commercial products have used distributed speech recognizers with a centralized file server, but this approach requires transferring large amounts of data between the file server and the local workstation speech recognizers.

### SUMMARY OF THE INVENTION

Embodiments of the present invention are directed to a system and method for use of speech recognition on a computer network where users roam from one network location to another. A local workstation on the network includes a speech recognition application having a local user profile associated with an application user. The local user profile includes at least one synchronization file containing user-specific speech recognition data. A network file location remote from the local workstation contains a user master profile corresponding to the local user profile, including a copy of the local synchronization file.

In further such embodiments the local synchronization file is copied to the master profile synchronization file, for example at the end of a user session with the speech recognition application, in response to a user command, or at regular periodic times. At the beginning of a user session with the speech recognition application, the master profile synchronization file may be merged into the local user profile to modify a base recognition vocabulary at the local workstation to reflect user changes. The merging may include replaying the master profile synchronization file into the local user profile to implement the user changes in the order in which they were originally made. The local synchronization file may be compared to the master profile synchronization file to determine when each was last modified, and the more recently modified synchronization file may be copied to the other synchronization file. In addition, data not in the local synchronization file may be copied from the local user profile to the master profile, for example, speech recognition acoustic data (such as data associated with user-correction of the speech recognition application) or one or more speech recognition acoustic models.

The at least one synchronization file may include user-specific command data to modify a base command structure for the speech recognition application to reflect user-specific command changes. The at least one synchronization file may also include user-specific vocabulary data to modify a base vocabulary structure for the speech recognition application to reflect user-specific vocabulary changes.

### BRIEF DESCRIPTION OF THE DRAWINGS

FIG. 1 shows a file architecture of a network-based dictation system for roaming users according to one specific embodiment of the present invention.

### DETAILED DESCRIPTION OF SPECIFIC EMBODIMENTS

Embodiments of the present invention provide distribution of speech recognition data between network file servers and individual workstations. When users roam between workstations, important changes (such as added words or macros) are reflected promptly even when changing workstations. This enhanced roaming capability is based on a new architecture of speech recognition files that supports cache synchronization between local and master files.

The speech recognition data can be assigned into two different priority classes: (1) high priority data needing to be available elsewhere on the network right away, and (2) lower priority data which can be transmitted to the network server on a less pressing basis. Some high priority data such as user-specific command grammar data and application switch settings may simply be copied between a local workstation file and a master network file location. Other cases may benefit from a more complex arrangement.

For example, new user-added words should be quickly available on other workstations, but whole vocabulary files are too large for convenient copying between workstations and the master network location. One solution is to divide the vocabulary files into vocabulary lists and n-grams, and also create a separate new file, referred to as a “Voc-Delta,” to store user-added words. The Voc-Delta includes high priority data that is synchronized immediately between the local workstation and a master network file. Then, when the user starts up on a new workstation, the user-specific vocabulary is recreated by “replaying” the Voc-Delta from the master file to change the base vocabulary in the local workstation to reflect all the user changes. On the other hand, acoustic data such as user-correction files (which may store user-corrected text and the associated speech waveform data) are lower priority data which can be transmitted to the master network server at lower priority, where they can be used for acoustic adaptation.

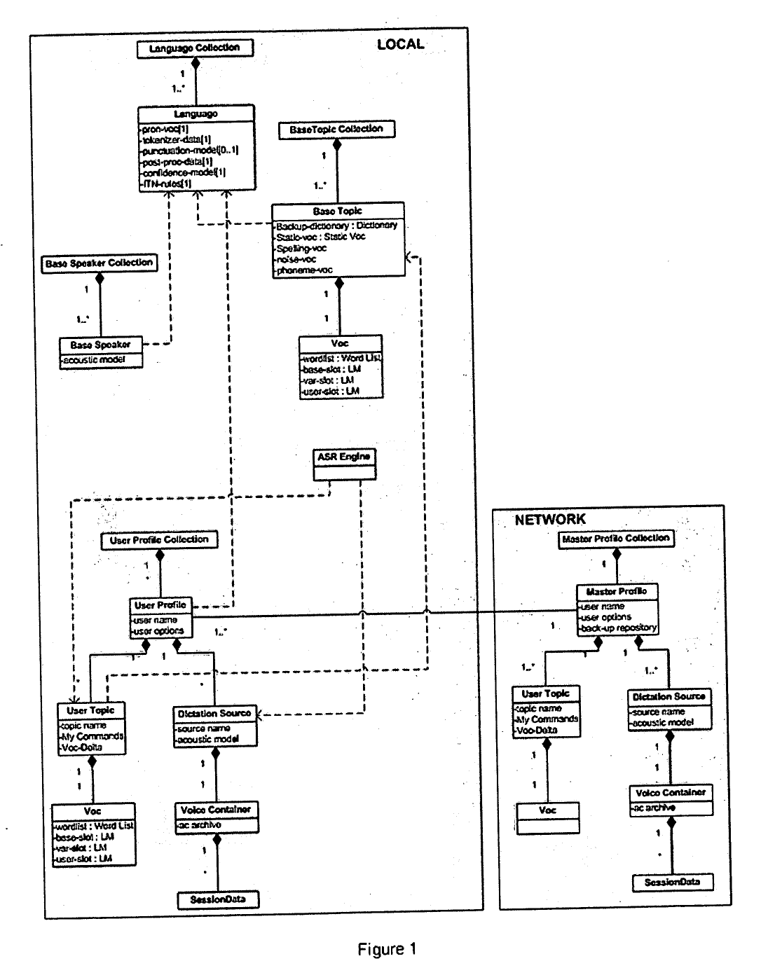

FIG. 1 shows a file architecture for one specific embodiment of a network-based dictation system for roaming users using distributed data files and a priority updating arrangement. FIG. 1 uses Unified Modeling Language (http://www.uml.org/) conventions to describe relations between data files. In fact, FIG. 1 is a particular kind of UML diagram called a class diagram using the composition relation (i.e. all the arrows are “composition”, which roughly means “is included in”). See, for example, UML Distilled: A Brief Guide to the Standard Object Modeling Language (2nd Edition), by Martin Fowler and Kendall Scott, incorporated herein by reference.

In FIG. 1, the file blocks for one individual workstation are on the left inside the Local box, and the file blocks stored on the network are on the right inside the Network box. Besides an ASR Recognition Engine, each local workstation also includes a Language Collection which holds recognition data and rules for one or more individual Languages. Each Language is also linked to a Base Speaker from a Base Speaker Collection and a Base Topic from a Base Topic Collection. Each Base Speaker holds acoustic speech recognition models for one or more individual Base Speakers, and each Base Topic contains various recognition dictionaries and vocabularies, and a Vocabulary Object containing a Word List and various language model grammars for that topic. A User Profile Collection also holds one or more individual User Profiles for each enrolled user which includes a user identifier and various user-specific operating options. Each User Profile is also linked to his or her respective Language in the Language Collection.

Each User Profile also includes a User Topic which includes a Topic Name linked to one of the Base Topics, custom user-defined application commands (“My Commands”), and the Voc-Delta which stores words that are added, deleted or modified by a user during dictation.

A link between the User Topic and a specific Base Topic also creates an instance of the associated Vocabulary Object under the User Topic. The User Profile is also connected to a Dictation Source Object containing a source name and associated acoustic models, which in turn is connected to a Voice Container that receives the raw speech data from each dictation session.

In addition, when each User Profile is first established at the workstation, roaming user synchronization files also are established at a shared network location (defined by the system administrator) for a master roaming profile. The user profile on the shared network location is referred to as the Master Profile. The Master Profile is structured the same way as the local User Profile with a corresponding User Topic and connected Vocabulary Object, and Dictation Source Object and connected Voice Container. The user can override the roaming feature and make their profile a “normal” profile on that specific workstation without roaming capability.

The Voc-Delta file in the User Topic is periodically updated to the Master Profile, for example, when the user saves the local User Profile. This may be thought of as merging the Master Profile Voc-Delta into the local User Topic by “replaying,” the Voc-Delta. This replaying modifies the base vocabulary in the local User Topic to add, modify, and delete vocabulary in the same order that the user originally made them. This replay mechanism provides a good match to the characteristics of the vocabulary - there are a few distinct changes which appear in a few distinct places in the file, so sending the whole vocabulary file is wasteful. The Voc-Delta also may reflect user changes to word pronunciation which also gets replayed to the local workstation from the Master Profile at log on so a roaming user gets the benefit of the new pronunciation when they next log on.

If the vocabulary is updated (for example, by merging a topic), then changes in the Voc-Delta file are merged into the updated vocabulary, and the Voc-Delta file in the Master Profile is reset to zero. The local Voc-Delta file is merged with the Master Profile Voc-Delta file when the local User Profile is closed, or changed. The maximum size of the Voc-Delta file may be limited, for example, to 500 Kbytes. This maximum size may be adjustable in some embodiments by admin-level users, who may have permissions and abilities to make other changes to various Master Profile and/or Voc-Delta features.

The shared network location of the Master Profile also may be defined at a later time via an Options dialog of the dictation software. Once the Master Profile is defined, roaming user functionality is available. The shared network location does not have to run the dictation software, and may be a simple network file repository. If a specific User Profile is loaded, the system may prevent setting the Master Directory.

A roaming User Profile can be loaded across the network onto a specific local workstation from the shared network location. An Open User Dialog may show all users that are found on the defined shared network location in alphabetical order. A given local workstation may only point to a single Master Profile Location at a time, however, different local workstations can point to different Master Profile Locations so that more than one Master Profile Location may be used in a networked environment.

A non-roaming local user may be moved to the roaming master location using a “Save to Roaming” advanced option in a Manage Users Dialog. This option may not be available if the dialog is pointing to either the roaming user master directory or the local cache directory. Setting this option may simply copy the entire user to the roaming location on the network. This option may also not be available when the Roaming User feature is turned off in the dictation software.

To implement such a roaming user system architecture, the dictation software should be able to distinguish between a network Master Profile and the corresponding local User Profile. The dictation software may do local caching of the User Profiles by default. And when there is no local cached version of a given User Profile, the dictation software will import the Master Profile by copying the User Profile data relevant to performing speech recognition. Caching may not be enabled for users that are created on and accessed over a network, but that do not exist in the Master Profile location. In specific embodiments, there may be an option to change the local cache location. The local cache location may not be settable to a network location, or to the default dictation software directory.

When a roaming User Profile is loaded, the dictation software first checks whether the network Master Profile is more recent than the local User Profile. If it is, the relevant files are copied from the Master Profile into the local User Profile. Then the local user Profile is loaded. If the network Master Profile is not available for some reason, (for example, the network is disconnected or the user roamed to a location that cannot access the network), then the locally cached User Profile will be loaded.

The Session Data in the local Voice Container will be copied to the network Master Profile when the local User Profile is unloaded at the workstation, or when the local workstation switches User Profiles to another user, or if the local User Profile is saved by the user. In one specific embodiment, the acoustic archive session in the local Voice Container is copied to directory location . . . \current\<voice>_container, where <Voice> is the name of the channel to which this data belongs.

User correction files and data generated during a dictation session may also be stored in the local Voice Container. When the current local User Profile is closed or changed, these correction files and associated data may be copied into the Master Profile Voice Container, after which, they may be deleted from the local workstation. The local Voice Container may continue to grow in size as long as the local User Profile has not updated the network Master Profile, and the acoustic archive data may continue to grow to some maximum limit, for example, 240 MBytes.

In some embodiments, the dictation software may include various performance optimizing tools such as accuracy optimizers. After running such tools, the local User Topic may be copied to the Master Profile. The My Commands file of customer user-defined commands (within the local User Topic) may be updated to the Master Profile whenever a user-defined command is added, deleted or modified, and/or when the local User Profile is saved and the My Commands module has set a flag that its content has changed.

A maximum size limit may be set for the Voice Container in the Master Profile, for example, 500 Mbytes. This may be implemented by looking at the size of the Master Profile Voice Container, and if it is under the maximum limit, additional data may be written (which may go over the maximum size limit). If additional optimizing training has been run at the local workstation, then the relevant data is copied to the Master Profile with a corresponding data update message to the user. When the local Voice Container is being copied to the Master Profile or when other data is being copied to the Master Profile, the Master Profile may be locked to prevent any other access at that time. Once the local Voice Container has merged with the Master Profile, the local Voice Container may be emptied.

A distributed speech recognition architecture supporting roaming users may also need to coordinate merging or copying of various information-related files (.ini files). For example, user-specific options may be stored in an options.ini file which needs to be coordinated between the local workstation and the network Master Profile so that the most recent version of that file is used when a roaming user logs into a given local workstation. Whenever the user logs out or saves his User Profile, the options.ini should be copied to the Master Profile. Some user-specific options from the Master Profile may occasionally be written to a local workstation ini-file, “local.ini.” The machine specific options in the local.ini file need not be updated with the Master Profile.

Some embodiments of the dictation software may also include an audio setup wizard (ASW) for optimizing the input microphone arrangement. Such information may be stored in an audio.ini file which is coordinated between the Master Profile and the local User Profile for that workstation. This file may be copied from the local workstation to the Master Profile as it is developed. If the audio.ini on the workstation is less recent than the version in the Master Profile, the Master Profile version of the audio.ini file may be copied back to the workstation.

In some specific embodiments, the audio.ini may contain various sub-sections describing workstation-specific audio characteristics. Thus, it may be the case that the ASW is run on a first workstation and the local audio.ini is updated. When the user logs off the first workstation, the audio.ini is updated in the Master Profile. When the user roams to a second workstation, the local audio.ini at the second workstation will be updated from the Master Profile.

Similarly, the audio.ini may contain information such as microphone information for a number of specific sound cards, dictation sources (how the speech signal gets in—.wav file, USB, or sound card), and operating systems (e.g., a specific microphone sub-file for one sound card and one operating system). If at startup the system finds a compatible microphone sub-file (i.e., one that has the same kind of sound card, same kind of dictation source, and the same operating system as the current workstation) it uses it. If it doesn't find information for a compatible microphone, it may force the user to go through the ASW to collect information about the current microphone, sound card, dictation source, and operating system.

There may be an information file for each User Topic, topics.ini, which should be updated when a change is made on the local workstation as soon as the change is committed. If the profile is locked, this may be attempted again at a user save event.

Changes in the various files may be tracked in a version file (“roaming.ver”) in the current directory of both the local User Profile and the network Master Profile. This can be used to determine if the local files are out of date. In some embodiments, there may be limited local backup and restore functionality for roaming users. Backup of the Master Profiles may be handled by a network administrator. Some embodiments may also restrict the ability to import and export roaming user profiles and their related data.

It may be possible to optimize the Master Profile by adapting on the data in the Master Profile Voice Container using an Acoustic Optimizer tool. Running the Acoustic Optimizer applies data in the Master Profile Voice Container which has been collected from all sessions gathered from various local workstations. Use of the Acoustic Optimizer may be scheduled on a daily, weekly, biweekly or monthly basis. It may not be necessary to schedule acoustic optimization separately for each user if the scheduler can set up a number of users at once. The acoustic optimizer may process the Master Profiles on a network node that is dedicated for adaptation. The profiles may be directly accessed and saved into the master location. The adaptation may start from the base acoustic profile and may not be incremental.

Some embodiments of the dictation software include an administrative tool, the Acoustic Optimizer Scheduler (ACOS), for enterprise-wide scheduling of acoustic optimization tasks for all the user profiles in the system. The ACOS may also feature a workstation (non-administrative) mode in which an individual user can set the task themselves on the local workstation, if they so chose to do so.

In one specific embodiment, the ACOS contains a window pane including a list-tree control which lists all the user profiles available to be administered. Another window pane may be a list control which details all the schedules set for the currently selected user profile. Double clicking on a schedule opens that instance of the schedule in the windows task scheduler window. Schedules can be set to run periodically (daily, weekly, monthly) or to run at a specific date/time. This window can be the standard task scheduler window provided with Microsoft Windows. If more than one schedule is set to run concurrently, then the program that runs the Acoustic Optimizer may queue the various tasks and attempt to run after remaining dormant for a given interval, e.g., 20 minutes. The administrator should be notified if there was insufficient data to successfully run the

Acoustic Optimizer. There may also be a batch mode for running the Acoustic Optimizer on a group of users at a scheduled time.

Various possible scenarios arise with respect to a dictation network supporting roaming users. For example, one computer in a networked group may have the dictation software installed and also be the location of the Master Profiles. That is, a local workstation rather than a dedicated server may be used for both dictation purposes and for storing the Master Profiles for roaming users. On that master/local workstation, the user is loaded in the “normal” manner; for the other computers in networked group, the user is roaming. Alternatively, some local workstations in a networked group might be relatively “close” (network bandwidth-wise) or relatively low on disk-space. In either case, such workstations might choose to treat some of the workstations as “normal” users over the network, and others of the workstations as “roaming” users.

In order to copy down changes in such situations, the Master Profile of a roaming user depends on a version file within the Master Profile accurately showing changes in the various affected files. But if a user is opened in a “normal” way over the network (not as a roaming user), then any changes may not be reflected in the version file. This can be addressed by a rule that if a speech recognition user is loaded in the “normal” way and there is a roaming version file present (but no “local cache” flag), the roaming version file will be updated appropriately. For example, any options changed by the user should result in a changed timestamp in the options.ini file (as when the user is opened as a roaming user), and when the user closes out from the workstation, the version number can be increased in the Master Profile version file. Similarly, any changes in user commands (the My Commands module) can be handled by a rule that when the user closes out from the workstation, check the flag in My Commands that indicates that the file has changed, and if so, increment the version number in the Master Profile version file. If the Audio Setup Wizard (ASW) is run, the audio.ini file changes, and the same change flag used for a roaming user can be used and checked when the user closes. Other files changes can be addressed in similar ways as required. Some files that may change during non-roaming operation such as session acoustic data, etc. may not be relevant to updating of the Master Profile and can be ignored when the user closes.

In one embodiment, the Voc-Delta includes added or deleted words, added or deleted pronunciations, and changes to vocabulary flags associated with words. It does not contain any language model statistics. Other embodiments include an LM-Delta file to update language model data related to a roaming user much like the Voc-Delta updates other data. For instance, in FIG. 1, the Vocabulary Object associated with each User Topic includes several language model slots including the base-slot, var-slot and user-slot. Some of these such as the base-slot never change (for example, the LM trigrams or the class LM), so these do not need to be updated for roaming users. Other parts can be changed by the user and the user's use of the system including the user slot (which contains statistics for this user) and the recent buffer, which contains the last 1000 words spoken by this user. The LM-Delta file may also include a local cache of language model interpolation weights which are used to weigh among the different slots when combining scores to produce a language model score.

TABLE 1
Summary of how data is copied and coordinated between local User
Profiles and network Master Profile:

| File Name/Type | Copied/Updated to Master Profile | Copied/Updated to local User Profile |
|---|---|---|
| Voc-Delta | Merged to Master Profile on user save & | Copied to local cache on user open & |
| | open. When vocabularies are copied up, the | merged into the voc if version # is |
| | Voc-Delta file is reset to zero in the Master | different on the server |
| | Profile for that topic. | |
| Roaming.ver | Whenever any local file (listed below) is | Whenever any local file (listed |
| | sent to the Master Profile, information for | below) is updated from the Master |
| | that file is merged into the master | Profile, information about that file in |
| | roaming.ver. | the local.ver is updated. |
| My Commands | Copied when User Profiles are saved, or | Copied at user open. |
| | user is closed and saved. | |
| Options.ini | Copied at user close, options dialog close | Copied on user open, options dialog |
| | when the timestamp on the local file has | open if version # is different on the |
| | changed. | server |
| User correction | Copied to Session Data in Master Profile as | Never |
| files | space allows. Local files are deleted after | |
| | being copied to the Master Profile. | |
| Raw session data | Copied to Session Data folder in Master | Never |
| (input voice data) | Profile (if it exists; once the Master Profile | |
| | Voice Container reaches its maximum size | |
| | limit, only “Train Words” and “Additional | |
| | Training” data may be collected). Local | |
| | copy is deleted & a zero-length file created. | |
| Audio.ini | Copied to Master Profile after running the | Copied if version # on server is |
| | ASW, or at user close if not copied | different; also copied right before |
| | successfully after ASW. | ASW is run. |
| .voc | Copies only after LME, Add Words From | Copied if version # on server is |
| | Doc, etc., are run | different. |
| .usr/.sig files | Never. ACO on server incorporates those | Copied if version # on server is |
| | changes. | different. |
| Backups | Never (only local) | Never |
| Topics.ini; | Handled by S2 in the CopyTopic; | Handled by S2 in the CopyTopic; |
| acoustic.ini | CopyAcoustic; ExportSpeaker functions. | CopyAcoustic; ExportSpeaker |
| | | functions. |
| nsuser.ini, | Never-machine dependant | Never |
| local.ini, | | |
| nssystem.ini, | | |
| natspeak.ini, | | |

*the “Network traffic at user open/close” feature in the roaming user dialog takes precedence over this list-i.e. if you have this turned on (off by default), the options.ini file would only copy at user close.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of performing speech recognition on a computer network, the method comprising:
providing on a local workstation of a computer network a speech recognition application including a local user profile associated with an application user, the local user profile including at least one synchronization file containing user-specific speech recognition data;
providing at a network file location remote from the local workstation a user master profile corresponding to the local user profile and including a copy of the at least one synchronization file.

2. A method according to claim 1, further comprising:
copying the local synchronization file to the master profile synchronization file.

3. A method according to claim 2, wherein the copying occurs at the end of a user session with the speech recognition application.

4. A method according to claim 2, wherein the copying occurs in response to a user command.

5. A method according to claim 2, wherein the copying occurs at regular periodic times.

6. A method according to claim 1, further comprising:
at the beginning of a user session with the speech recognition application, merging the master profile synchronization file into the local user profile to modify a base recognition vocabulary at the local workstation to reflect user changes.

7. A method according to claim 6, wherein the merging includes replaying at least a portion of the master profile synchronization file into the local user profile to implement the user changes in the same order in which the user changes were originally made.

8. A method according to claim 1, further comprising:
comparing the local synchronization file to the master profile synchronization file to determine when each was last modified; and
copying the more recently modified synchronization file to the other synchronization file.

9. A method according to claim 1, further comprising:
copying data not in the local synchronization file from the local user profile to the master profile.

10. A method according to claim 9, wherein the data copied includes speech recognition acoustic data.

11. A method according to claim 10, wherein the speech recognition acoustic data includes data associated with user-correction of the speech recognition application.

12. A method according to claim 9, wherein the data copied includes a speech recognition acoustic model.

13. A method according to claim 1, wherein the synchronization file includes user-specific command data to modify a base command structure for the speech recognition application to reflect user-specific command changes.

14. A method according to claim 1, wherein the synchronization file includes user-specific vocabulary data to modify a base vocabulary structure for the speech recognition application to reflect user-specific vocabulary changes.

15. A method according to claim 1, wherein the synchronization file includes user-specific operating options for the speech recognition application.

16. A system adapted to use the method according to any of claims 1-15.
